(19) United States
(12) Patent Application Publication
(10) Pub. No.: US 2010/0163113 A1
(43) Pub. Date: Jul. 1, 2010

(54) BEVERAGE CONTAINER AND ASSEMBLY OF SUCH A CONTAINER AND A TAPPING DEVICE

(75) Inventor: Bart Jan Bax, Blaricum (NL)

Correspondence Address: Pearne & Gordon LLP, 1801 East 9th Street, Suite 1200, Cleveland, OH, 44114-3108, US

(73) Assignee: HEINEKEN SUPPLY CHAIN B.V., 1017 ZD Amsterdam (NL)

(21) Appl. No.: 12/293,762

(22) PCT Filed: Mar. 19, 2007
(86) PCT No.: PCT/NL07/50112

§ 371 Date: May 14, 2009

(30) Foreign Application Priority Data
Mar. 20, 2006 (NL) 1031410

(51) Int. Cl. B67D 1/00

(52) U.S. Cl. 137/12.5; 222/394

(57) ABSTRACT

A beverage container (1) provided with an inner space, at least partly filled with carbonated beverage and a valve assembly (15) attached in the beverage container, in particular a top surface (4) thereof, which valve assembly comprises a valve body (21) biased in a closing direction against a valve seat (20), and wherein, preferably, an engaging means (26) extending outside the inner space is provided, wherein a pressure control device (36) is provided which comprises a reservoir (37), filled with a pressure gas, which reservoir is in communication with the inner space, at least during use, preferably via a pressure control device, and wherein the dispensing device comprises an operating device (40) for pressing the valve body away from the valve seat, which operating device comprises a part of a beverage dispensing channel (48, 52) and is provided with means (64) for maintaining the valve assembly in an opened position.

The invention relates to a beverage container.

From practice, beverage containers are known in which carbonated beverages are stored, such as beer, for storage, transport and dispensing thereof.

It is known to furnish beer in a keg which can be arranged under, for instance, a bar, and which can be connected to a tapping column with a tapping cock of a tapping device with the aid of a tapping line fixedly connected thereto, which is connected to the keg with a standard handle-tapping head. With this, simultaneously, a CO₂ line is connected for supply of CO₂ in order to pressurize the content of the keg. If the tapping cock is opened, the beer is forced from the keg. Such kegs typically have a content of, for instance, 20, 30 or 50 litres. For larger volumes, usually, a cellar beer installation is used. Such systems are location-restricted or can only be moved with much effort.

It is further known to package beer in, often smaller, metal kegs, which can be emptied by means of gravity. To that end, the keg is designed as a steel or aluminum container having, in a wall adjacent the bottom, a tapping cock that can be opened and closed manually.

In a more advanced embodiment, as known from, for instance, NL 1008601, the container is provided with a pressure control device with which a pressure gas can be introduced into the container, in order to keep the inner space of the container at a pre-selected pressure. A valve assembly with an operating mechanism coupled thereto is provided on the top side of the container. A dispensing tube extends from the valve assembly outside the circumference of the container, so that a glass can be held under the outflow opening thereof. Directly above the valve assembly, the operating mechanism comprises a handle with which the valve assembly can be opened. A cooling jacket can be provided around the outer circumference of the container, for cooling the container.

It is further known to furnish an assembly of a tapping device and a container, wherein the container can be included in the tapping device and can be coupled to a tapping cock by a somewhat flexible hose. Examples thereof are known from, for instance, NL 1006948, NL 1006949, NL 1006950 and WO2004050541A2. With such devices, in the inner space of the container, a flexible bag is included in which the beverage is stored. The tapping device comprises an air pump and cooling device. During or after placement of the container in the tapping device, the air pump is connected to the container so that air can be pumped between the bag and the container wall. The somewhat flexible hose is coupled to a tapping cock or operating means for a tapping cock, so that, upon operation of the tapping cock, beverage can be pumped via this hose from the tapping device and can be collected in a glass or the like. Here, the cooling means ensure that the beverage is cooled. With such an assembly, a power source is to be provided for at least the air pump, so that in many places, this assembly cannot be used.

The object of the invention is a beverage container for dispensing beverage under pressure. To that end, a beverage container according to the invention is characterized by the features of claim 1.

A beverage container according to the invention is furnished with a pressure control device, which, during use, effects control of the pressure in the container. It is preferred that the pressure be maintained substantially constant. Here, an operating device is provided with a first coupling means and a second coupling means which is movable relative to the first coupling means. With the aid of the first coupling means, the operating device can be positioned relative to the valve assembly, while with the second coupling means, the valve assembly can be operated and be fixedly connected to the container, for opening a beverage valve. Engaging means are provided for fixing, with the beverage valve in opened condition, the second coupling means relative to the first coupling means and/or the container.

In a second aspect, a beverage container according to the invention is characterized in that the first and second coupling means have cooperating guide means, for obtaining at least a crude positioning of the second coupling means relative to the beverage valve, in particular to the operating means thereof. Here, preferably, the second coupling means have further guide means for at least a fine-positioning of the second coupling means relative to said beverage valve. These can be formed by, for instance, a tapering end of a channel part or an insertion opening for a stem of a valve.

Preferably, a first position of the second coupling means relative to the first coupling means is provided, in which the second coupling means do not contact the valve body and/or operating means thereof, while a further position is provided in which the second coupling means contact at least the valve body or an operating means thereof.

As, with a container according to the invention, in such an embodiment, the operating device in a first position is uncoupled from the valve, it can be stored in assembled condition and be furnished to a user, without there being the risk of inadvertent operation of the valve. By, then, pressing the second coupling means to the further position, the valve can be opened and be maintained opened. Thus, the possibility is presented to include the container in a closed tapping device, and still be able to tap beverage, through the pressure that is automatically controlled in the container.

Alternatively, the first coupling means can be fixed to the container and the second coupling means to the first coupling means, again, for keeping the valve assembly opened after it has been opened.

It is preferred that at least a part of the beverage dispensing channel extends through the second coupling means in a manner such that a first end thereof can be slid in, on, against and/or over the valve body, for obtaining a liquid communication with the inner space of the container, while an opposite, second end is connected to a dispensing hose, preferably flexible, which may be provided with, for instance, a valve fixedly connected thereto, that can be operated by a tapping device in which the container can be included. Also, the dispensing hose can have a relatively free and open end and, with such a tapping device, form a hose tap.

In a further, more detailed elaboration, the valve assembly is attached, with the aid of a flange, in or to a top surface of the container, while the second coupling means are or can be fixed thereto, in particular through a snap connection. Alternatively or in addition thereto, the coupling means can be fixed to the top surface and/or to a circumferential edge of the top surface, in particular a flange connecting the top surface to a longitudinal wall of the container.

The invention further relates to an assembly of a container according to the invention and a tapping device, wherein the tapping device is designed for receiving the container, and is provided with tapping means for connection to or cooperation with a beverage dispensing channel, in particular a dispensing hose of the container.

In clarification of the invention, embodiments thereof will be further elucidated on the basis of the drawing. In the drawing:

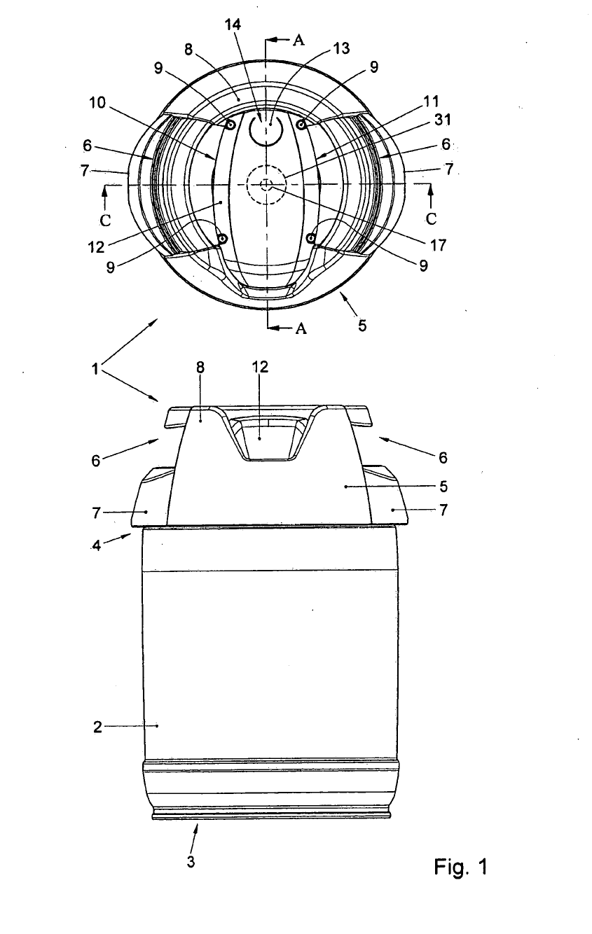

FIG. 1 shows, in top plan view and side view, a container according to the invention;

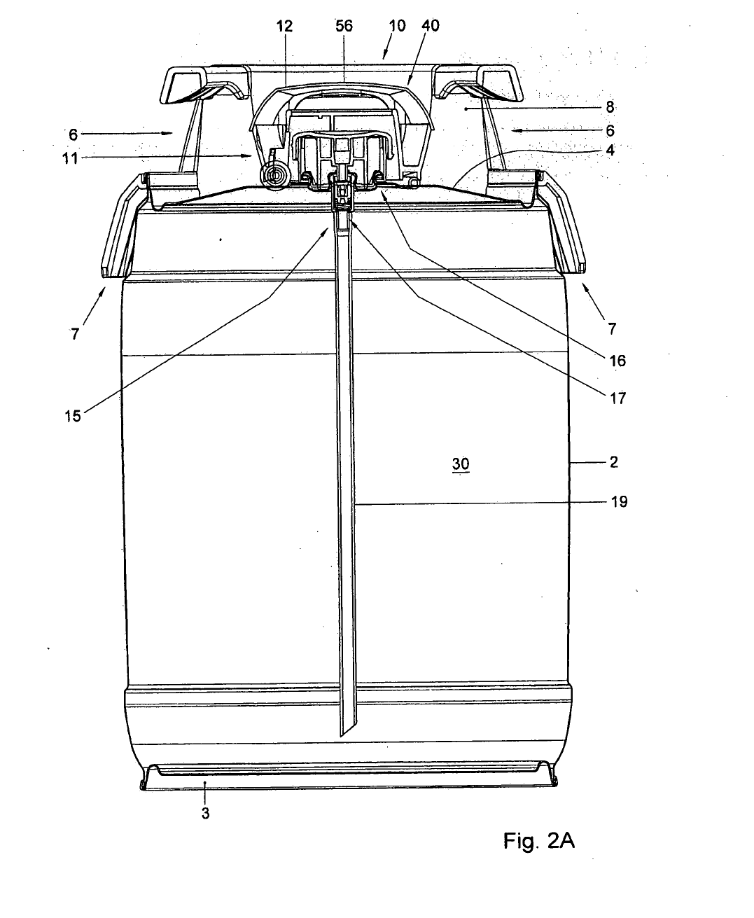

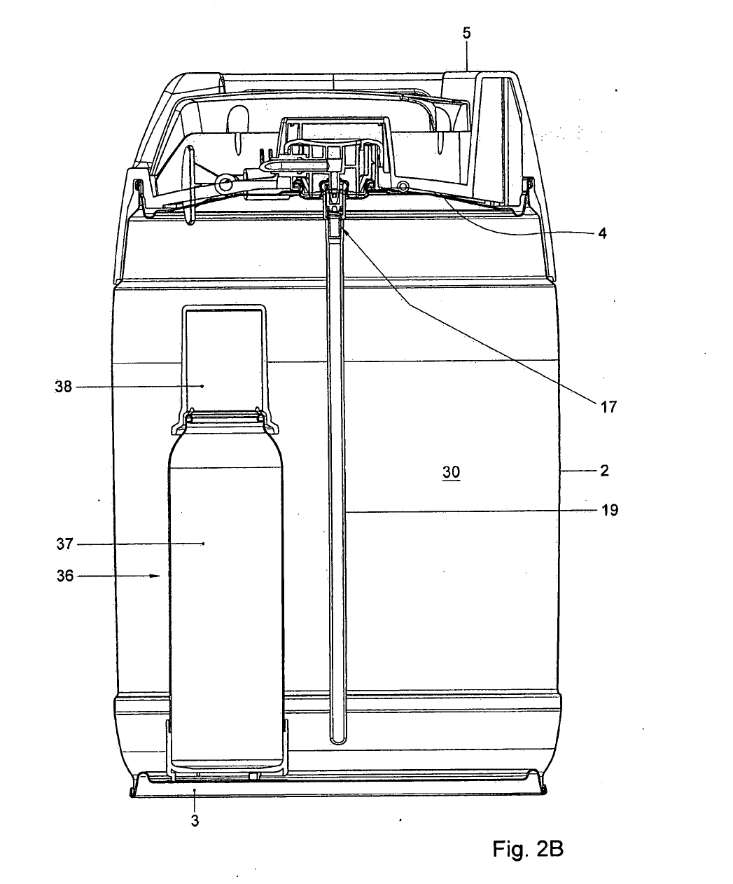

FIGS. 2A and B show, in cross-sectional views, a container according to the invention, according to the lines C-C and A-A in FIG. 1, respectively;

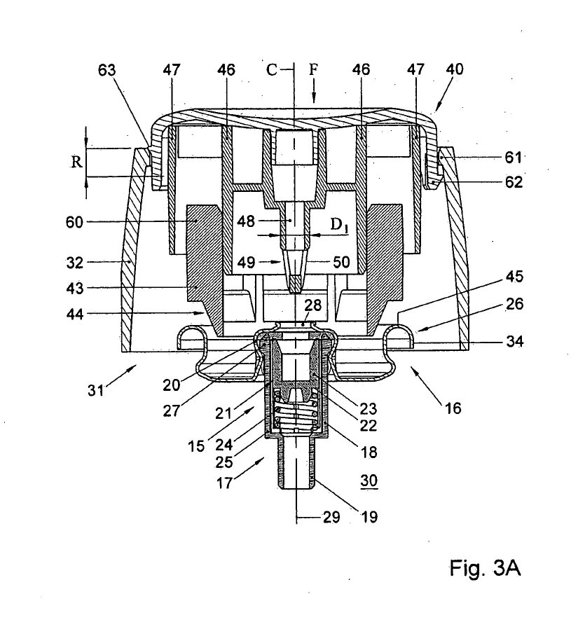

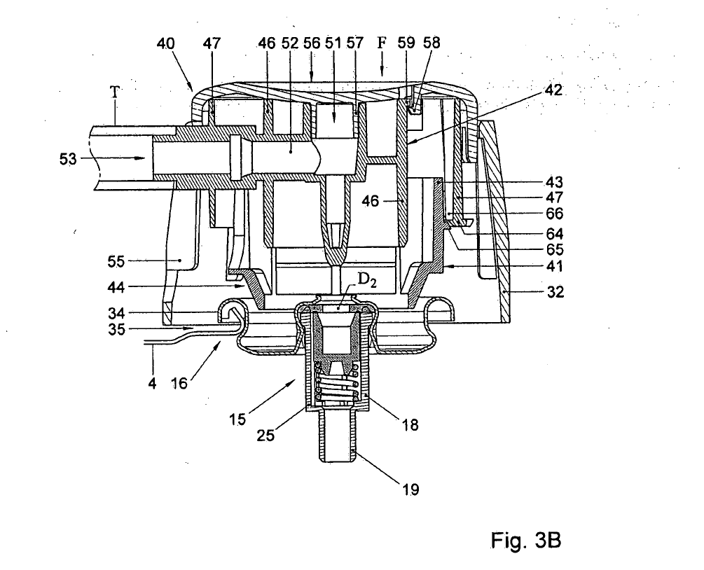

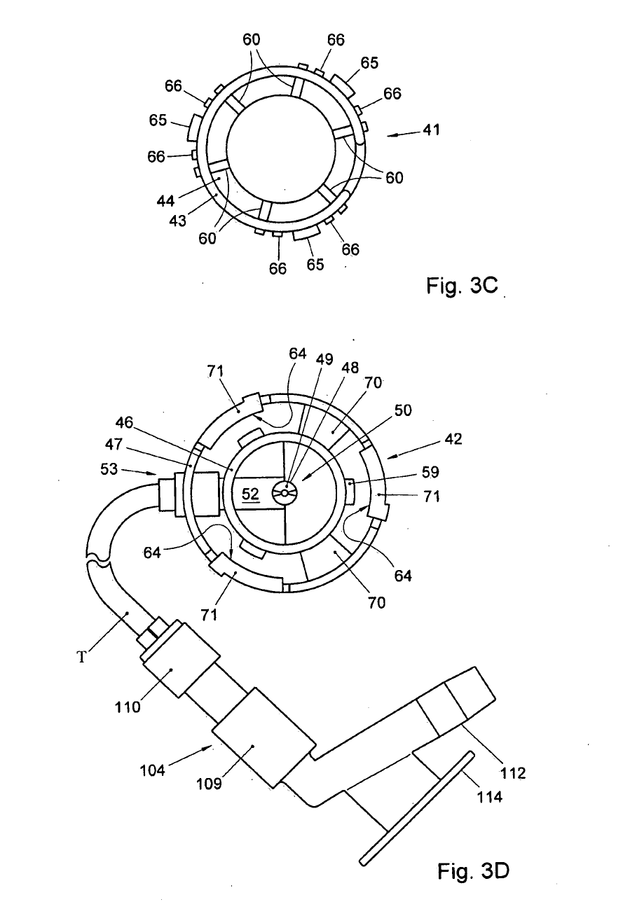

FIGS. 3A and B show, in cross-sectional views, a part of a container according to FIG. 2A, 2B, respectively, with operating means in a first position;

FIGS. 3C and 3D show, in top plan view, a first coupling means and in bottom view, a second coupling means, respectively;

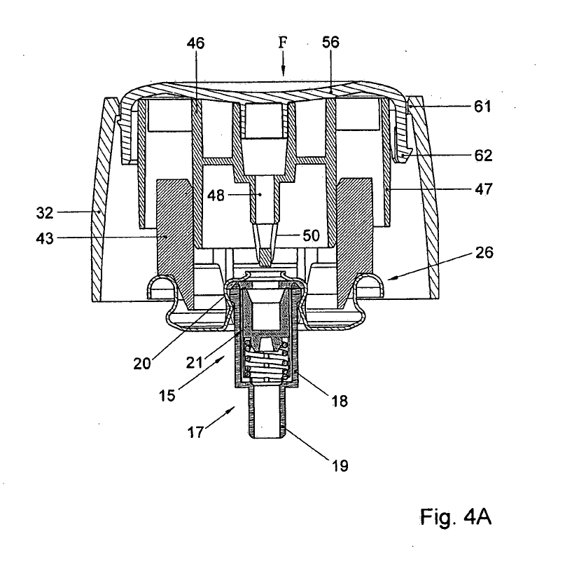

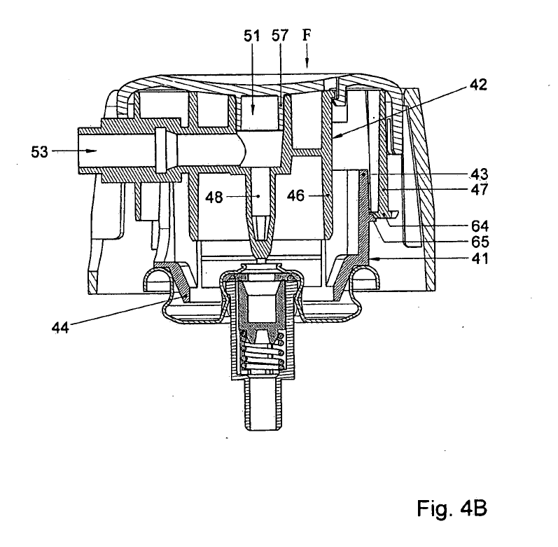

FIGS. 4A and B show, in cross-sectional views, a part of a container according to FIG. 2A, 2B, respectively, with operating means in a second position;

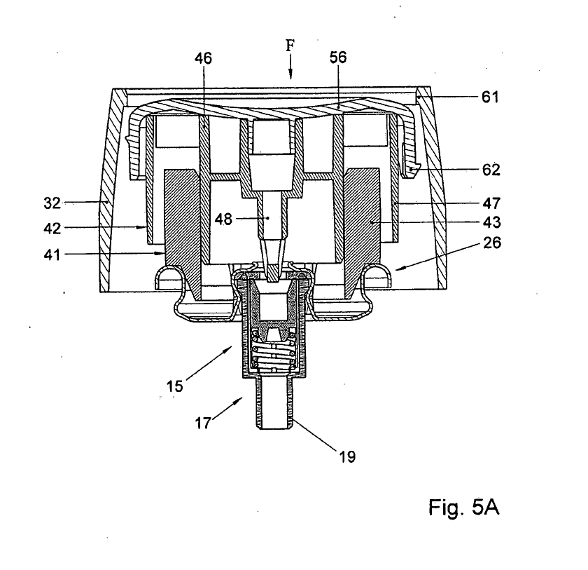

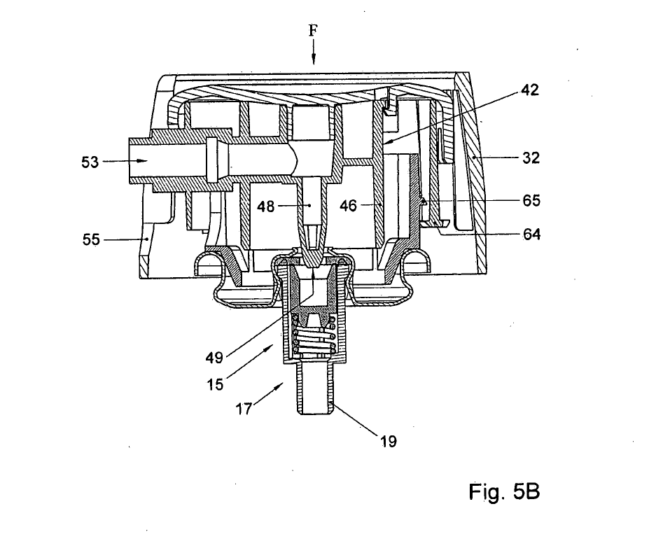

FIGS. 5A and B show, in cross-sectional views, a part of a container according to FIG. 2A, 2B, respectively, with operating means in a third position;

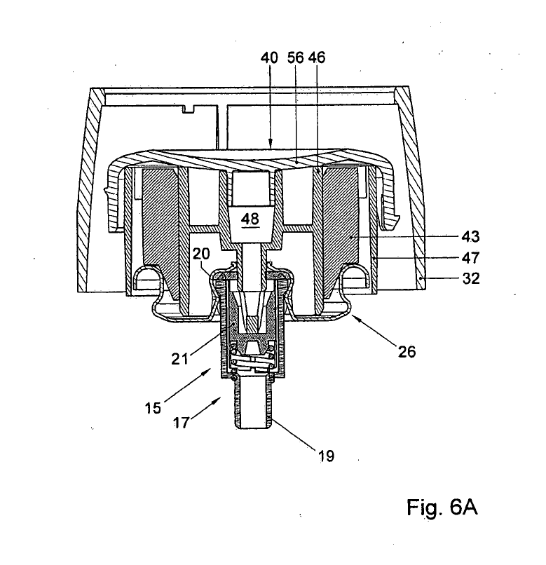

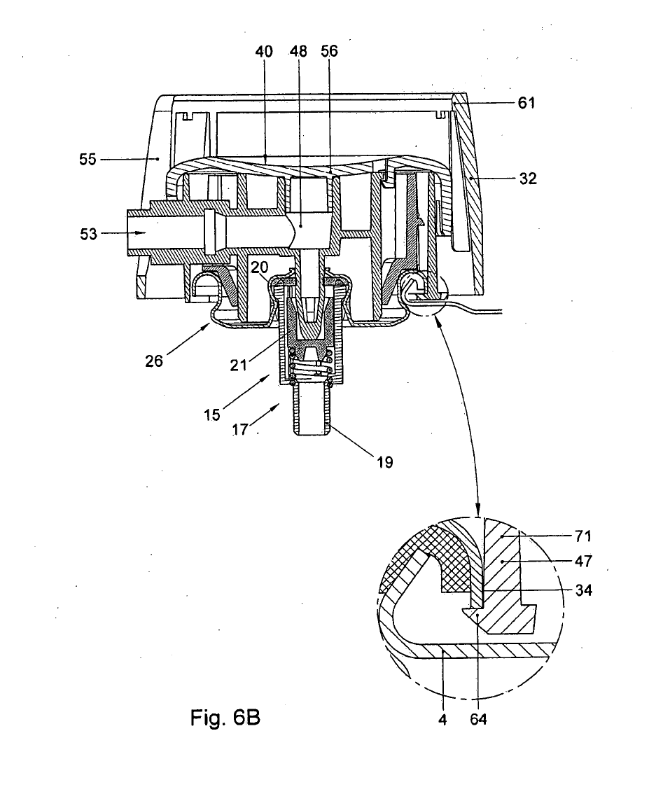

FIGS. 6A and B show, in cross-sectional views, a part of a container according to FIG. 2A, 2B, respectively, with operating means in a fourth position; and

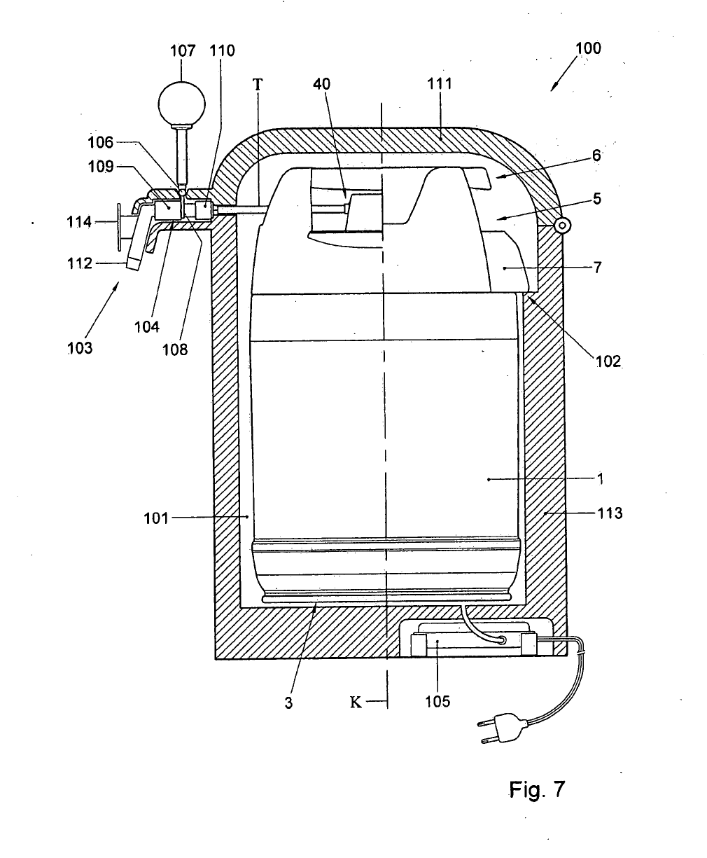

FIG. 7 schematically shows, in partly cross-sectional side view (left half) and front view (right half), a container according to the invention, included in a tapping device.

In this description, identical or corresponding parts have identical or corresponding reference numerals. The embodiments shown are shown merely by way of illustration and should not be construed to be limitative in any manner. In this description, the terms above and below will be used, referring to a normal use of the containers shown, while a container is disposed on a bottom surface or bottom, and a dispensing opening or valve assembly is located thereabove.

In FIG. 1, a top plan view and side view of a container 1 are shown. This container 1, manufactured from, for instance, metal or plastic, is provided with a closed wall 2, a bottom 3 and a top side 4. On the top side 4, a top ring 5 is provided, through, for instance, a snap connection, clamping connection, gluing or other connecting means. The top ring comprises two handles 6, located diametrically opposite each other, and two projections 7 located below the handles, projecting somewhat beyond the wall 2 and from which, if desired, a tapping device 100 can be suspended as shown in FIG. 7. The top ring 5 has a circumferential wall 8 in which the handles 6 have been recessed, and with which it rests on the top, and surrounds a space 10. In the space 10, at a small distance above the top surface, a bridge 11 extends, connected at both sides to the circumferential wall 8. In FIG. 1, this bridge 11 is covered by a lid 12 in which an opening 14 covered by a break lip 13 is provided. The lid 12 is connected to the bridge by seal means, such as, for instance, weld connections, glue connections or snap-off connections, so that it can be seen whether the lid has been taken from the bridge. By pushing a finger into the opening 14, the lid can be pulled away upward, while breaking the seal means.

In the top side 4 of the container 1, a valve assembly 15 is provided, in the exemplary embodiment shown fixed by a folded seam connection 16. In this embodiment, the valve assembly 15 comprises a valve 17, in particular an aerosol container type valve assembly. In the exemplary embodiment shown, this is a female valve 17. The valve 17 comprises a housing 18 connected at the bottom side to, or merging into a riser 19 reaching adjacent the bottom 3 of the container 1. The housing 18 is substantially cylindrical with an open top. On the top is placed a ring 20, preferably made of a somewhat flexible plastic or rubber. Inside the housing 18, under the ring 20, a valve body 21 is provided which is somewhat bowl-shaped, with an open side turned towards the ring 20. The valve body has a closed bottom 22 and an edge 23, which edge 23 tapers somewhat on the side remote from the bottom. Between the bottom 22 and the riser 19, a spring 24 is included, so that the valve body 21 is pressed by the edge 23 against the spring 20, and seals thereagainst. Hence, the ring 20 forms a valve seat. Between the edge 23 of the valve body 21 and the wall 25 of the housing 18, at least one passage 26 and/or some clearance is provided.

The valve assembly 15 further comprises a profiled flange 26 having in a central area a collar 27, within which the ring 20 and the housing 18 are attached in a manner known per se, preferably by clamping and/or form-locking. The collar 27 is provided at the top with an opening 28 which is approximately coaxial to an axis 29 of the ring and of the valve body 21. By pressing the valve 21 downwards during use, against the spring 24, space is created between the ring 20 and the edge 23, so that a fluid communication is created, from the riser 19, and hence an inner space 30 of the container, and the opening 28, or a part of operating means extending therein during use, as will be further described, along the valve body 21. Upon removal of the pressure on the valve body, this will be pressed back upwards by the spring, so that the valve is closed again. A male valve can also be used for that matter, wherein a hollow stem is provided on the valve body, extending through the opening 28 and having at least one outflow opening at a top end or a tilting valve that can be opened through tilting of the valve body.

Such valve assemblies, in particular valves, are sufficiently known from practice, as are variants thereon that can be utilized within the invention and are directly clear to the skilled person.

In the bridge 11, an opening 31 is provided, preferably having a neck 32 extending in the direction away from the top surface 4, and extending in top plan view (as is schematically represented in interrupted lines in FIG. 1), at some distance around the flange 26. The flange 26 is attached by a folded seam connection 16 to the top surface 4 in a manner such that between a downward folded edge 34 of the flange 26 and the top surface 4, a crack 35 is provided. The purpose thereof will be explained further.

As clearly appears from FIG. 2, in the inner space 30, a pressure control device 36 is provided, attached to, for instance, the bottom 3. This pressure control device comprises a container 37 with a pressure regulator 38 thereon with which a valve, comparable to, for instance, the valve 17, can be operated. In the container 37, at an excess pressure, an amount of pressure gas such as CO₂ is included, optionally in a gas adsorbing and/or gas absorbing material, such as activated carbon or zeolite. As a result, when there is less pressure, a larger amount of gas can be stored than without this material. The pressure regulator is built up such that, at a pressure drop in the container 1, for instance because beverage is dispensed therefrom, it causes the valve to open for some time, so that gas from the container 37 can flow into the inner space 30, and returns the pressure to a pre-selected level. Then, the valve is automatically closed again, until, once more, the pressure falls below a pre-selected value. Such a pressure control device is known from, for instance, EP1064221, EP1140658 or U.S. Pat. No. 5,368,207, which applications are understood to be incorporated herein with respect to the set-up and operation of the pressure control device. Other pressure control devices for that matter can also be utilized within the invention, for instance with gas containing containers or compartments, inside and/or outside the container, at least the inner space 30, which pressure control devices are suitable for single use only, or for repeated use.

As appears from FIGS. 2A and B in general, and is further elucidated in FIGS. 3-6, above the valve assembly 15 and in particular in the opening 31 and the neck 32, an operating device 40 is included, which, in FIG. 1, is confined under the lid. In FIGS. 3-6, for the sake of simplification, only the operating device 40, the neck 32 separate from the bridge 11 and the valve assembly 15 are represented.

In this embodiment, the operating device 40 comprises a first coupling means 41 and a second coupling means 42 movable relative thereto. The first coupling means 41 comprises a body 43 which is substantially cylindrical and which is provided, on a side proximal to the flange 26 with a locating edge 44. The flange 26 is provided, at a distance from the collar 27, with an upstanding ring 45 of which the folded edge 34 forms part. The locating edge 44 is designed such that it can center the body 43 relative to the flange 26 and, more importantly, relative to the valve 17.

The second coupling means 42 comprises a first wall 46 substantially closed upon itself and a second wall 47 closed upon itself, extending therearound viewed in top plan view. Adjacent a top side, the two walls 46, 47 are interconnected by small bridges 70. Within the innermost, first wall 46, a first channel part 48 is provided, extending concentrically within the two walls, with a longitudinal axis C that is approximately parallel to the axis 29 of the valve 17. In this embodiment, the channel part 48 is provided at the side proximal to the valve 17 with a tapering end 49, which is closed but has, for instance, one or, for instance, two or more inlet openings 50, for instance somewhat elongated in a longitudinal direction parallel to the direction of the axis C. The outer diameter D1 of the channel part 48 is substantially equal to or slightly greater than the inner diameter D2 of the diameter of the opening in the ring 20, so that this seals off thereagainst. Here, a tapering configuration offers the advantage that inserting and centring thereof during placing and activation is further simplified. However, the stem can also be straight and/or have an open end. In this embodiment, the channel part 48 has an open end 51 at the side remote from the end 49, so that formation of the channel part through, for instance, injection molding is possible in a relatively simple manner. In the second coupling means 42, further, a second channel part 52 is provided, extending at an angle of, approximately, for instance 90 degrees relative to the first channel part 48, through the two walls 46, 47. The second channel part 52 links up by a first end to the first channel part 48, while the opposite end 53 is open and extends through a recess 55 in the neck 32. During use, a dispensing hose T is attached in or to the second channel part 52. Together, the two channel parts 48, 62 form a part of a beverage dispensing channel in the second coupling means 42.

A cover cap 56 is attached over the second coupling means 42 and has, in a center part thereof, a stub 57 that fits in the open end 51, which is thereby closed off. As shown in FIGS. 3B and D, a number of snap elements 58 are provided on the cover cap 56, which can engage under projections 59 adjacent the top side of the first wall 46, for further securing the cover cap 56 to the second coupling means 42.

On a side of the body 43 facing inwards, the first coupling means 41 has a number of partitions 60 extending approximately radially inwards, as guide elements. The first wall 41 abuts against the edges of the partitions 60 facing each other, so that a longitudinal guide for the second coupling means 42 in the direction F is obtained, inside the first coupling means 41. As the first coupling means 41 can be centred relative to the valve 17 by the locating edge 44, when it is pressed in the direction F against the flange 26, a good centring of the second coupling means 42 and, hence, of the first channel part 48 relative to the opening 28 and the valve body 21 is obtained.

The neck 32 is provided at the top with an edge 61 projecting somewhat inwards, while the cover cap 56 is provided at the outside with at least one outward projecting element 62, for instance a snap finger or snap edge. At a distance R above the projection 62, which distance R is approximately equal to the height of the edge 61, from the cover cap 56 support means 63 extend outwards which, in the condition shown in FIG. 3, rest on the edge 61, while the or each projecting element 62 engages below the edge 61. As a result, the cover cap 56 and, hence, the second coupling means 42 are fixed relative to the neck 32. The end 49 of the first channel part 48 is thus maintained at a relatively great distance from the valve 17, so that the valve 17 is prevented from being opened by it. Furthermore it can thus be ensured that form changes in, for instance, the bridge, the coupling means, the stem and/or the container have no influence, or only minimum influence on the operation of the valve 17 and, in particular, do not cause it to open prematurely.

At the bottom side of the second wall 47 of the second coupling means 42, at least one hooking element 64 is provided, extending inwards, preferably on a somewhat flexible or movable wall part. Furthermore, from the body 43, at least one supporting element 65 extends outwards, on which, in the position shown in FIG. 3, the or a hooking element 64 rests. At a distance above the or a supporting element, a number of projections 66 is provided, which engage above the hooking elements 64 and are confined in the direction F. As a result, in the position shown in FIG. 3, the first coupling means 41 is suspended from the second coupling means 42 and hence, indirectly from the neck 32. That is why operation of the valve 17 in the first position as shown in FIG. 3B is not possible.

As the first and second coupling means and the cover cap are coupled to each other, and to the hose, this whole can be placed in one go, which simplified assembly. Preferably, the top ring and the operating device are manufactured from plastic, preferably recyclable plastic, and it is possible to first place the operating means on the bridge, then the lid and then, this whole can be connected to the top of the container, which can simplify production even further. However, also, a different order can be used, for instance, first, placing the top ring, then the operating device and, finally, the lid. Variations thereon will be directly clear to the skilled person. As clearly shown in FIG. 3D, a valve, tap or other type of shut-off 104 can be attached to the hose T or be integrally formed therewith, whereby the passage in the hose is closed and can be released. An example of such a shut-off 104 is known from, for instance, EP1284918 and WO01/92142 and can be indicated as in line valve. Such a shut-off is also utilized by, for instance, Heineken, the Netherlands, in the Beertender®. An advantage of such a shut-off is that after opening of the valve assembly, this can be maintained opened, without beverage flowing away inadvertently.

From the first position, the second coupling means 42 can be pressed downwards in the direction F by pressing the cover cap 56 slightly downwards, to the second position as shown in FIG. 4. Here, the supporting means 63 are pressed beyond the edge 62, while the locating edge 44 is pressed inside the edge 45 and is thus centred. The hooking elements 64 then rest on the or a supporting element 65 on the first coupling means 41.

From the second position as shown in FIG. 4, the operating means 40 can be brought into a third position, as shown in FIG. 5, by pressing the cover cap 56 further down. Here, the hooking elements 64 are pressed beyond the or each respective supporting element 65. When they are provided on a flexible wall part 71, this can be done with relatively little force. Here, the end 49 is pressed into the opening 28, well centred through guidance of the first wall 46 by the partitions 60 of the centred second coupling means 42.

From this third position, the operating means 40 can be brought into a fourth position, as shown in FIG. 6. To that end, the cover cap 56 is pressed down even further, such that the end 49 of the first channel part 48 is pressed against the bottom 22 of the valve body 21 and then, as a result, the valve body 21 is pressed away from the ring 20 and, hence, the valve is opened. In this fourth position, the hooking elements 64 are forced under the edge 34 into the crack 35. As a result, the second coupling means 42 is fixed under the edge 34 functioning as engaging element, with the hooking elements 64 functioning as engaging means in the fourth position, and the valve 17 is maintained open. Preferably, this engagement cannot be removed without damage. The first coupling means 41 is then confined between the flange 26 and the connections between the two walls 46, 47 of the second coupling means 42. As a result, further movement is prevented. Furthermore, the valve 17 is prevented from being closed again. Some movement in the direction of opening F is allowable. The apron 41 can furthermore confine the hooking elements 58 in the opened position of the valve in a manner such that the cover cap 56 can no longer be removed.

In the fourth position, the valve is opened and beverage, pressurized by the pressure control device 36, can be brought via the riser 19, along the valve body 21 into the channel part 48, 52 and from there through the hose T.

In the pressure control device, preferably, relatively much CO₂ per litre of beverage is included, so that during the entire tapping time, a relatively stable pressure build-up and, hence, a stable tapping behaviour is maintained. It is preferred that for each litre of beverage, at least approximately 3.2 grams of CO₂ or more are provided, preferably considerably more, for instance more than 3.5 grams per litre. For instance, approximately 4 grams of CO₂ per litre can be included, or at least approximately 0.44% by weight. Naturally, by experiment, an optimum can be determined in further detail.

In FIG. 7, a container 1 is shown, included in a tapping device 100. This tapping device 100 comprises a chamber 101 in a tank-shaped part 113, which can be closed by a lid 111. In the chamber 101, suspension edges 102 can be provided from which the container 101 can be suspended with the aid of the projections 7. The tapping device 100 is provided with a tapping mechanism 103 in which a tap or valve 104 or similar shut-off can be inserted that is fixedly connected to the hose T. By operating the tapping mechanism 103, the tap or valve 104 can be opened so that the beverage can be dispensed from the hose T. In the tapping device 100, further, cooling means 105 are provided with which the beverage in the container 1 can be cooled and can be kept cool.

In the embodiment shown, in FIG. 7 on the right hand side of the cutting line K, the tapping device 100 with container 1 is shown in partly cross-sectional front view, at the left hand side in partly cross-sectional side view. Here, the hose T is visible with the closing device 104, which is inserted in the tapping mechanism 103, which comprises a handle 107, arranged to hinge about an axis 106, which handle can move a first valve part 109, via a fork 108, relative to a second valve part 110. With it, the shut-off 104 can be opened and closed. Such a tap assembly is described in more detail in the earlier-mentioned patent application WO01/92142. On an outflow 112 of the shut-off 104, a shield 114 is provided, visible from the outside of the tapping device 100 and which may be provided with branding. During closure of the lid 111, the shut-off is positioned and confined.

In one variant (not shown), a flexible bag is provided on the valve, around the riser, in which bag the beverage is included and wherein, between the wall 2 and the bag, the pressure control device is provided. With it, the beverage is separated from the gas and thus, each desired type of gas can be utilized, such as air, or even a liquid such as water, without affecting the beverage, while furthermore, other non-carbonated beverages such as juices and wine can be dispensed too. The pressure control device can also be placed completely or partly outside the container.

The invention is not limited in any manner to the exemplary embodiments represented in the drawings and the description. Many variations thereon are possible within the framework of the invention as outlined by the claims.

For instance, instead of a female valve, a different valve assembly can be utilized, while the part of the dispensing channel can extend through the first and second coupling means in different manner. The first and second channel part can for instance include a different angle, the first channel part may be open at the bottom side and the first and second coupling means 41, 42 can be formed differently. Also, in principle, the cover cap may be formed fixedly with the second coupling means, the bridge can be provided in a different manner, instead of the partitions, other guide means can be provided, and the top ring and the container can be integrally formed. Also, the valve can be attached in the container in a different manner. The top ring and the bridge can be manufactured in one piece, but can also be assembled from different parts.

These and many other variations, among which combinations of parts of the embodiments shown, are understood to fall within the framework of the invention as outlined by the claims.

1. A beverage container provided with an inner space, at least partly filled with carbonated beverage and a valve assembly attached in the beverage container, in particular a top surface thereof, which valve assembly comprises a valve body biased in a closing direction against a valve seat, and wherein, preferably, an engaging means extending outside the inner space is provided, wherein a pressure control device is provided which comprises a reservoir, filled with a pressure gas, which reservoir is in communication with the inner space, at least during use, preferably via a pressure control device, and wherein the dispensing device comprises an operating device for pressing the valve body away from the valve seat, which operating device comprises a part of a beverage dispensing channel and is provided with means for maintaining the valve assembly in an opened position.

2. A beverage container according to claim 1, wherein the operating device is provided with first and second coupling means, wherein the second coupling means are at least partly movable within the first coupling means for moving the valve body away from the valve seat and wherein engaging means are provided for engagement of said engaging element and/or the first coupling means in a manner such that said valve body is maintained in the position moved away from the valve seat.

3. A beverage container according to claim 1, wherein said part of the beverage dispensing channel extends through first and/or the second coupling means.

4. A beverage container according to claim 2, wherein the second coupling means are movable relative to the first coupling means between a first and a further position, while, in the first position, the first coupling means extend further outside the second coupling means than in the further position.

5. A beverage container according to claim 2, wherein the engaging element comprises an edge extending at least partly and preferably completely around the valve assembly, in particular an edge of a part with which the valve assembly is attached to the container, wherein the second coupling means are provided at a side proximal to the container with the engaging means, which can at least engage onto, on or under said edge.

6. A beverage container according to claim 2, wherein the first coupling means comprise a body which comprises the second coupling means at least partly.

7. A beverage container according to claim 2, wherein the first coupling means comprise an at least partly tubular body, while the operating device comprises a part that is movable within said tubular body, guided by at least a portion thereof.

8. A beverage container according to claim 7, wherein said substantially tubular body is provided on a side proximal to the container with second guide means, in particular a locating edge for guiding and positioning the operating device relative to the valve assembly, in particular the valve body.

9. A beverage container according to claim 1, wherein the valve assembly is attached by means of a folded edge connection in a top of the container, which folded edge connection comprises a collar, surrounded by a flange, wherein a valve is provided in or under an opening in said collar and the operating device, in particular first and/or second coupling means are provided with a locating edge on the side proximal to the container for centring thereof relative to the valve assembly through cooperation with said folded edge and/or collar.

10. A beverage container according to claim 2, wherein the second coupling means comprise said part of the beverage dispensing channel, which part is somewhat T-shaped with a first part with a first and an opposite, second end, and a second part that links up, between said first and second end, with the first part, wherein a cover cap is provided closing off the second end of the first part, while the first end is provided with at least one inlet opening.

11. A beverage container according to claim 1, wherein the pressure control device is included in the inner space.

12. A beverage container according to claim 1, wherein in the inner space, a bag is included in which the beverage is confined, which bag links up with the valve assembly and wherein the pressure control device is included in the inner space, preferably between the bag and a wall of the container, separated from the beverage.

13. A beverage container according to claim 2, wherein on the second coupling means, in particular on a part of the beverage dispensing channel extending therethrough, a further part of the beverage dispensing channel is provided, in particular an at least partly flexible dispensing tube or dispensing hose.

14. A beverage container according to claim 13, wherein, in said further beverage dispensing channel, a valve is provided for closing off and opening the beverage dispensing channel.

15. A beverage container according to claim 2, wherein the first and/or second coupling means are attachable to the container, in particular to or on a profiling adjacent the valve assembly.

16. A beverage container according to claim 1, wherein in the reservoir, a first volume of pressure gas is provided and in the inner space a second volume of beverage, wherein for each litre of beverage in the second volume at least 3 grams, preferably more than 3.2 grams and more preferably at least 3.4 grams of CO₂ are provided in the first volume.

17. An assembly of a beverage container according to claim 1 and a tapping device, wherein the tapping device is provided with means for including the container at least partly and with tapping means for connection to or cooperation with a beverage dispensing channel of the container or a shut-off included therein.

18. An assembly according to claim 17, wherein the tapping device can be closed all around the container and wherein during or prior to placing of the container in the tapping device, the operating device is operated in a manner such that at least partly because of that, the valve body is pressed away and/or is maintained pressed away from the valve seat, in particular is brought and maintained in a fourth position.

19. A method for tapping beverage, in particular carbonated beverage such as beer, wherein the container comprises an inner space in which beverage is included and a valve assembly for dispensing the beverage from the inner space, and a pressure control device preferably integrated in or on the container for controlling the pressure in the inner space, wherein on the valve assembly, an operating device is pressed in for opening and maintaining opened the valve assembly.
